(19) United States
(12) Patent Application Publication
(10) Pub. No.: US 2025/0173821 A1
(43) Pub. Date: May 29, 2025

(54) Multi-resolution Transformer for Video Quality Assessment

(71) Applicant: Google LLC, Mountain View, CA (US)

(72) Inventors: Junjie Ke, San Jose, CA (US); Tianhao Zhang, Courbevoie (FR); Yilin Wang, Sunnyvale, CA (US); Peyman Milanfar, Menlo Park, CA (US); Feng Yang, Sunnyvale, CA (US)

(21) Appl. No.: 18/839,577

(22) PCT Filed: Mar. 23, 2022
(86) PCT No.: PCT/US2022/021539

§ 371 Date: Aug. 19, 2024

(51) Int. Cl. G06T 3/4046; G06T 3/4092; G06T 7/00; G06T 13/80; G06V 10/764; G06V 10/82

(52) U.S. Cl. CPC G06T 3/4046; G06T 3/4092; G06T 7/0002; G06T 13/80; G06V 10/764; G06V 10/82; G06T 2207/10016; G06T 2207/20016; G06T 2207/20021; G06T 2207/20084; G06T 2207/30168; G06T 2210/36

(57) ABSTRACT

A no-reference video assessment framework employs a multi-resolution input representation and a patch sampling mechanism on a video having multiple frames 302 to aggregate information across different granularities in spatial and temporal dimensions. The framework effectively models complex spacetime distortions that occur in user generated content-type videos. According to one aspect, the framework embeds video clips 302 as multi-resolution patch tokens using complementary modules. This includes a multi-resolution video embedding module 322, and a space-time factorized Transformer encoding module 324, 326. The multi-resolution video embedding module 322 is configured to encode multi-scale quality information in the video, capturing both global video composition from lower resolution frame and local details from larger resolution frames. The space-time factorized Transformer encoding module 324, 326 aggregates the spatial and temporal quality from the multi-scale embedding input, and is configured to output a quality score 330 for the input video.

### BACKGROUND

Video analysis is used in many different types of applications. Some types of video analysis, such video quality assessment (VQA), may quantify the perceptual quality of videos (as opposed to still images). Other types of video analysis may be used to classify aspects of a video, such as objects appearing therein. Such analysis can include analyzing imagery, including video imagery, using convolutional neural networks (CNNs). However, issues such as unstable or shaky cameras, camera lens flaws, varying resolutions and frame rates, different algorithms and parameters for processing and compression, may all adversely impact the assessments for video.

Various VQA methods focus on full reference (FR) scenarios, in which distorted videos are compared against their corresponding pristine reference. In recent years, there is an explosion of user generated content (UGC) videos on social media platforms. For many UGC videos, the high-quality pristine reference can be inaccessible. Thus, no-reference (NR) VQA models can be used for ranking, recommending and optimizing UGC videos. Certain NR-VQA models leverage the power of machine learning to enhance results. Many known deep-learning approaches use CNNs to extract frozen frame-level features and then aggregate them in the temporal domain to predict the video quality. Since frozen frame-level features are not optimized for capturing temporal-spatial distortions, this could be insufficient to catch diverse spatial or temporal impairments in UGC videos. For example, transient glitches or frame drops may not have big frame pixel difference, but it can greatly impact user-perceived video quality. Moreover, predicting UGC video quality often involves long-range spatial-temporal dependencies, such as fast-moving objects or rapid zoom-in views. Since convolutional kernels in CNNs are specifically designed for capturing short-range spatial-temporal information, they cannot capture dependencies that extend beyond the receptive field. This limits CNN models' ability to model complex spatial-temporal dependencies in UGC VQA tasks, and therefore such an approach may not effectively aggregate complex quality information in diverse UGC videos.

### BRIEF SUMMARY

Aspects of the technology employ a no-reference VQA framework based on the Transformer architecture, which employs a multi-resolution input representation and a patch sampling mechanism to effectively aggregate information across different granularities in spatial and temporal dimensions. Unlike CNN models that are constrained by limited receptive fields, Transformers utilize the multi-head self-attention operation that allows the model to attend over all elements in the input sequence. As a result, Transformers can capture both local and global long-range dependencies by directly comparing video quality features at all spacetime locations. The approach discussed herein can achieve state-of-the-art performance on multiple UGC VQA datasets including LSVQ, LSVQ-1080p, KoNVID-1k and LIVE-VQC.

According to one aspect, a method for processing videos comprises grouping and rescaling, by one or more processors, neighboring input video frames of a single video into a pyramid of multi-resolution frames including both lower resolution frames and higher resolution frames; sampling, by the one or more processors, the pyramid of multi-resolution frames to obtain a set of patches; encoding, by the one or more processors, the set of patches as a set of multi-resolution input tokens; generating, by a spatial transformer encoder implemented by the one or more processors, a representation per frame group for a plurality of time steps; aggregating, by a temporal transformer encoder implemented by the one or more processors, across the plurality of time steps; and generating, by the one or more processors based on the aggregating, a quality score associated with a parameter of the video.

The method may further comprise prepending a set of classification tokens to the set of multi-resolution input tokens. Alternatively or additionally, generating the quality score may include applying aggregated output from the temporal transformer encoder to a multi-layer perceptron model. The quality score may be a mean opinion score. Alternatively or additionally to the above, the encoding may include capturing both global video composition from the lower resolution frame and local details from the higher resolution frames.

The grouping and rescaling may include: dividing the neighboring input video frames by a group of N; and proportionally resizing the group of N to N different resolutions preserving a same aspect ratio; wherein an i-th frame is resized to shorter-side length i×l, where l is a smallest length. Alternatively or additionally, sampling the pyramid of multi-resolution frames to obtain a set of patches may include aligning patch grid centers for each frame. Here, during model training, the method includes randomly choosing a center for each frame along a middle line for a longer-length side, and for inference, using the center of the video frames.

Alternatively or additionally, Sampling the pyramid of multi-resolution frames to obtain a set of patches may include: from a first one of the neighboring input video frames, uniformly sampling grid patches to capture a complete global view; and for following ones of the neighboring input video frames, linearly sampling spaced-out patches to provide local details. Alternatively or additionally, a patch size P is the same for all of the multi-resolution frames in the pyramid. Here, for the i-th frame in the pyramid, the distance between patches is set to (i−1)×P. Alternatively or additionally, sampling the pyramid of multi-resolution frames to obtain a set of patches includes forming a tube of multi-resolution patches, the tube having the same center in through the pyramid of multi-resolution frames.

According to another aspect, a video processing system comprises memory configured to store imagery and one or more processors operatively coupled to the memory. The one or more processors are configured to: group and rescale neighboring input video frames of a single video into a pyramid of multi-resolution frames including both lower resolution frames and higher resolution frames; sample the pyramid of multi-resolution frames to obtain a set of patches; encode the set of patches as a set of multi-resolution input tokens; generate, by a spatial transformer encoder implemented by the one or more processors, a representation per frame group for a plurality of time steps; aggregate, by a temporal transformer encoder implemented by the one or more processors, across the plurality of time steps; and generate, based on the aggregating, a quality score associated with a parameter of the video.

The one or more processors may be further configured to prepend a set of classification tokens to the set of multi-resolution input tokens. Alternatively or additionally, generation of the quality score includes applying aggregated output from the temporal transformer encoder to a multi-layer perceptron model. Alternatively or additionally, encoding the set of patches includes capturing both global video composition from the lower resolution frame and local details from the higher resolution frames. Alternatively or additionally, grouping and rescaling neighboring input video frames includes: division of the neighboring input video frames by a group of N; and proportionally resizing the group of N to N different resolutions preserving a same aspect ratio; wherein an i-th frame is resized to shorter-side length i×l, where l is a smallest length.

Alternatively or additionally, the one or more processors may be configured to sample the pyramid of multi-resolution frames to obtain a set of patches by alignment of patch grid centers for each frame. Here, during model training, the one or more processors are configured to randomly choose a center for each frame along a middle line for a longer-length side, and for inference the one or more processors are configured to use the center of the video frames.

Alternatively or additionally, the one or more processors may be configured to sample the pyramid of multi-resolution frames to obtain a set of patches as follows: from a first one of the neighboring input video frames, uniformly sample grid patches to capture a complete global view; and for following ones of the neighboring input video frames, linearly sample spaced-out patches to provide local details. The one or more processors may be configured to sample the pyramid of multi-resolution frames to obtain a set of patches by formation of a tube of multi-resolution patches, the tube having the same center in through the pyramid of multi-resolution frames. A patch size P may be the same for all of the multi-resolution frames in the pyramid.

Alternatively or additionally, the one or more processors may be further configured to assign quality scores to different videos in order to prioritize the different videos for serving.

### BRIEF DESCRIPTION OF THE DRAWINGS

FIGS. 1A-B illustrate an example for a multi-resolution Transformer for video quality assessment in accordance with aspects of the disclosure.

FIG. 1C illustrates distortions visible on an original high-resolution video that may disappear when resized to a lower resolution

FIG. 2 illustrates a Transformer-type architecture for use in accordance with aspects of the technology.

FIGS. 3A-B illustrate a model overview of the MRET architecture in accordance with aspects of the technology.

FIG. 4 demonstrates the patch sampling mechanism from a frame group in accordance with aspects of the technology.

FIG. 5 illustrates an example of multi-resolution video frames embedding in accordance with aspects of the technology.

FIG. 6 illustrates a table of test results in accordance with aspects of the technology.

FIG. 7 illustrates another table of test results in accordance with aspects of the technology.

FIGS. 8A-F visualize temporal attention in accordance with aspects of the technology.

FIG. 9 illustrates a table of ablation study results for multi-resolution input in accordance with aspects of the technology.

FIG. 10 illustrates a table of ablation study results for a number of grouped frames in accordance with aspects of the technology.

FIG. 11 illustrates a table of results for initializing an MRET model from pretrained checkpoints in accordance with aspects of the technology.

FIG. 12 illustrates a table of ablation study results for a frame sampling method in accordance with aspects of the technology.

FIGS. 13A-B illustrate a system for use with aspects of the technology.

FIG. 14 illustrates a method in accordance with aspects of the technology.

### DETAILED DESCRIPTION

### Overview

Aspects of the technology employ a Transformer-type approach on VQA tasks in order to effectively model the complex spacetime distortions common in UGC videos.

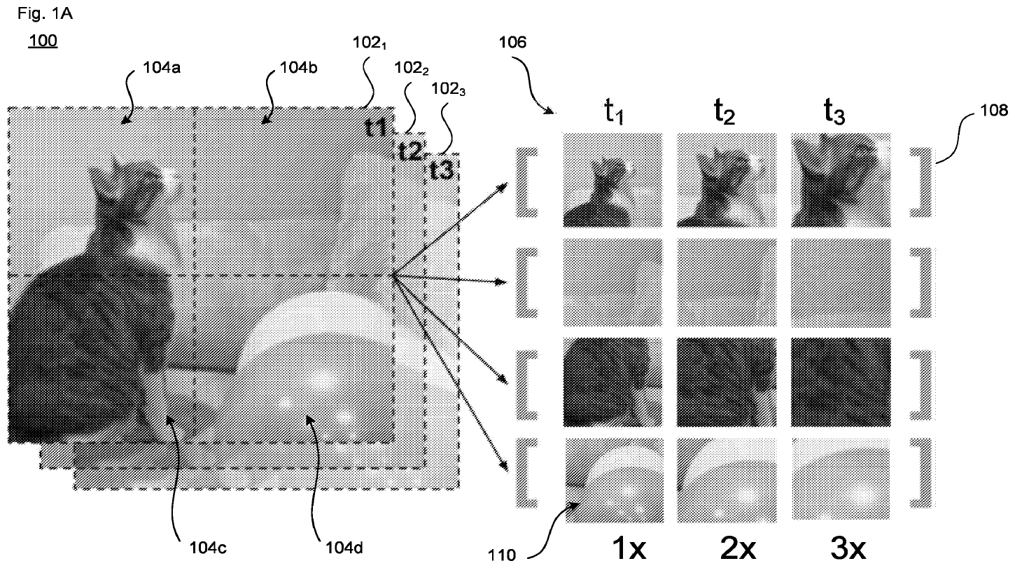

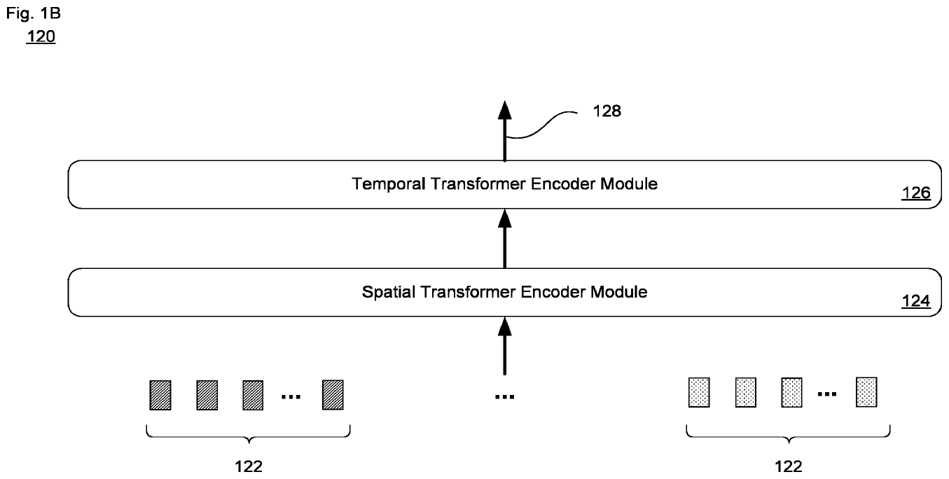

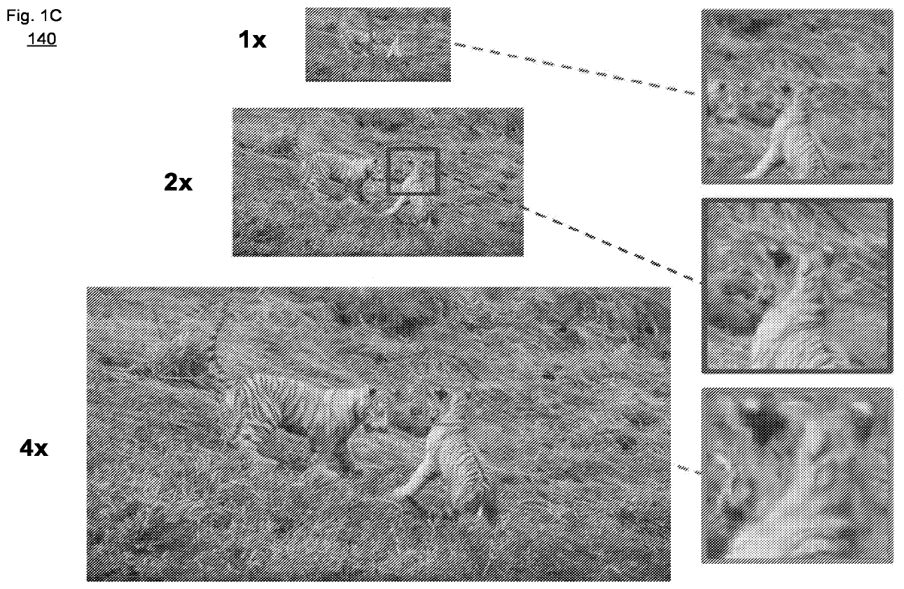

FIGS. 1A-B illustrate an example for a multi-resolution Transformer for VQA, denoted as a Multi-Resolution Transformer (MRET), to efficiently extract and encode the multiscale quality information from the input video. Neighboring frames are grouped together to build a multi-resolution representation composed of lower-resolution frames and higher-resolution frames. Intuitively, the lower-resolution frames capture the global composition of the video, and the higher resolution frames contain local detail that might be hard to detect or invisible in lower resolution frames. To effectively handle this multi-resolution input sequence and reduce the complexity of processing the entire high resolution video frames, a multi-resolution patch sampling mechanism is employed to sample patches from the multi-resolution frame input. The sampled patches from the multi-resolution pyramid form the final multi-resolution video representation, which is used as the input to the Transformer encoder.

As presented in FIG. 1A, a series of video frames 1021, 1022, 1023, etc. has been taken at different points in time t1, t2, t3, etc. Each frame may be broken into multiple non-overlapping segments 104 (e.g., 104a, 104b, 104c, 104d as shown. The segments may include one or more specific features of the imagery. In this example, an upper part of a cat is in segment 104a and a lower part of the cat is in segment 104c. Balls or balloons are seen in segment 104d, while a couch or chair is seen in segment 104b.

The segments 104 for each frame 102 are then arranged into a multi-resolution video representation 106, as shown in matrix form on the right side of FIG. 1A. Each row 108 in the matrix includes a set of different resolution sub-images 110 associated with a corresponding one of the segments 104. In this example, there is an original (1×) resolution image, a medium (2×) resolution image, and a large (3×) resolution image. It is not necessary to store the original resolution for the resized frames. As shown, each different resolution image (1×, 2×, 3×) 110 is associated with a different timestamp (t1, t2, t3). The multi-scale video representation is configured to capture both global composition and local details of video quality as a series of patches.

As shown in example 120 of FIG. 1B, patches 122 (which are sampled from the proportionally resized frames with different resolutions) are first applied to a spatial Transformer encoder module 124, which extracts a sequence of spatial-temporal tokens from the input video. These tokens are provided to a factorized temporal Transformer encoder module 126, which aggregates the information. Thus, the patch sampling can be scaled accordingly (sample uniformly throughout the grid). Factorization of both the spatial and temporal encoder modules (as a “factorized spatial-temporal encoder”) can be done to effectively process the large number of spatial-temporal tokens in videos. This greatly reduces model size, improving efficiency and scalability. According to one aspect of the technology, a video quality score 128 or other metric for the input video can be output from the model.

Integrating both global and local video perception can result in a more accurate and comprehensive VQA model. Other vision or image-dependent tasks can also benefit from multi-scale features. This can include video classification, video recommendation, video search, etc. As a result, various system and applications can be enhanced to address video quality issues. For example, one could use the quality metrics to rank videos according to their quality scores in order to prioritize serving high quality videos. Alternatively or additionally, the quality scores can be used to filter poor quality videos. For video curation, video post-processing operations can be chosen that lead to a high quality score.

Human perceived video quality is affected by both the global video composition (e.g., content, video structure and smoothness) and local details (e.g., texture and distortion artifacts). It is hard to capture both global and local quality information when using fixed resolution inputs. Generally, video quality is affected by both global video composition and local details. Although downsampled video frames provide the global view and are easier to process for deep-learning models, some distortions visible on the original high-resolution videos may disappear when resized to a lower resolution. View 160 of FIG. 1C illustrates an example of this. Here, some visible artifacts on the high resolution video are not obvious when the video is downsampled.

Incorporating multi-resolution views into the model as discussed herein enables the Transformer's self-attention mechanism to capture diverse quality information on both fine-grained local details and coarse-grained global views. The result is a multi-resolution Transformer suitable for video quality assessment (MRET), as well as other types of vision/image-dependent tasks. This includes a multi-resolution video frame representation and the corresponding multi-resolution patch sampling mechanism that enable the Transformer to capture multi-scale quality information in diverse UGC videos. As discussed further herein, MRET was tested on a number of large-scale UGC VQA datasets. Results show it outperforming conventional approaches by large margins on LSVQ and LSVQ-1080p. It was also able to achieve state-of-the-art performance on KoNVID-1k and LIVE-VQC without fine-tuning, thereby demonstrating its robustness and generalization capability

### General Transformer Approach

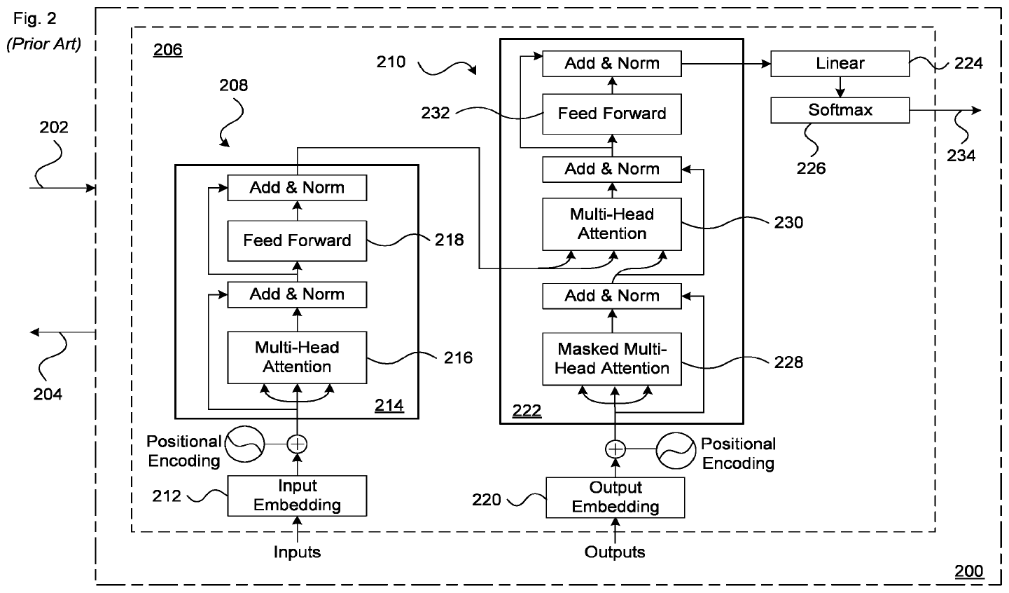

The MRET employs a self-attention architecture, e.g., the Transformer neural network encoder-decoder architecture. An exemplary general Transformer-type architecture is shown in FIG. 2, which is based on the arrangement shown in U.S. Pat. No. 10,452,978, entitled “Attention-based sequence transduction neural networks”, the entire disclosure of which is incorporated herein by reference.

System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Overall MRET Architecture

UGC video quality is highly diverse since UGC videos are captured under very different conditions like unstable/shaky cameras, imperfect camera lens, varying resolutions and frame rates, different algorithms and parameters for processing and compression. As a result, UGC videos usually contain a mixture of spatial and temporal distortions. Moreover, the way viewers perceive content and distortions may also impact the final perceptual quality of the video. Sometimes transient distortions such as sudden glitches and defocusing can significantly affect the overall perceived quality, which makes the problem even more complicated. Due to the diversity of spatial-temporal distortions and the complexity of human perception, quality assessment for UGC videos should be taken into account both global video composition and local details. The MRET architecture captures video quality at different granularities. According to one aspect for VQA, the architecture embeds video clips as multi-resolution patch tokens.

MRET is comprised of two main parts, namely a multi-resolution video embedding module, and a space-time factorized Transformer encoding module. According to one aspect, MRET need not employ a decoder such as decoder neural network 210 discussed above. The multi-resolution video embedding module is configured to encode the multi-scale quality information in the video, capturing both global video composition from lower resolution frame and local details from larger resolution frames. The space-time factorized Transformer encoding module aggregates the spatial and temporal quality from the multiscale embedding input.

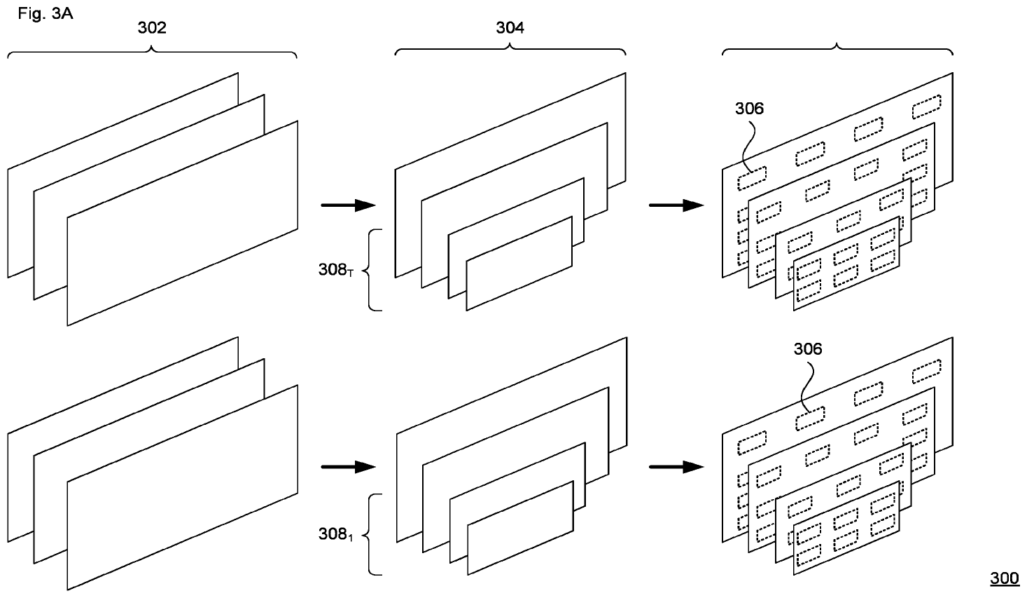

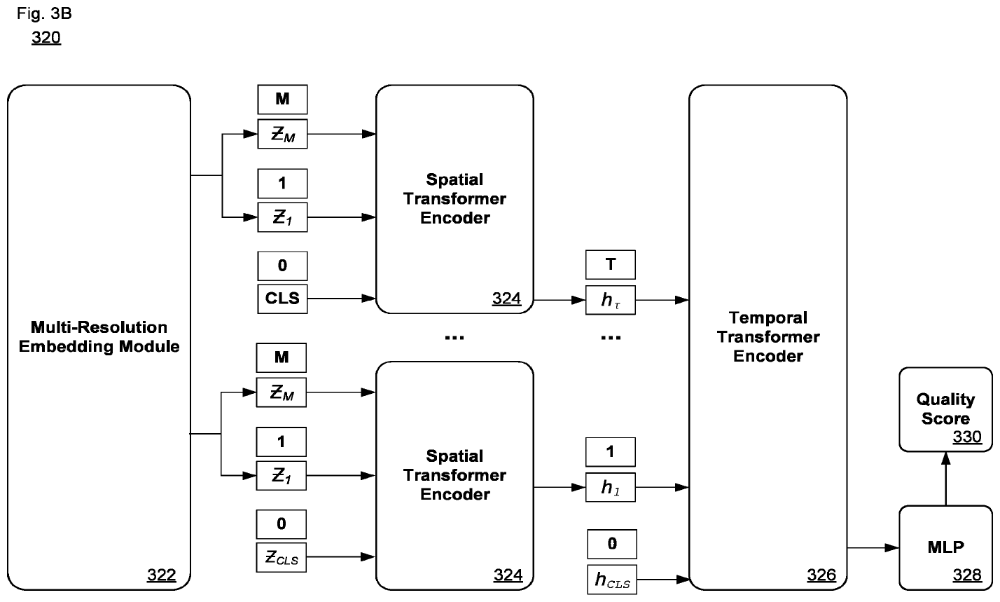

FIGS. 3A-B illustrate a model overview of the MRET architecture in accordance with aspects of the technology. As shown in view 300 of FIG. 3A, neighboring input video frames 302 are grouped and rescaled into a pyramid of low-resolution and high-resolution frames 304. Patches 306 (shown in dashed lines in FIG. 3A) are sampled from the multi-resolution frames 304 by the multi-resolution embedding module 322 (FIG. 3B) and encoded as the Transformer input tokens (e.g., tokens 0, 1, . . . , M) as shown in view 320 of FIG. 3B. Here, tokens 0-M represent the video multi-resolution embedding, while tokens Z₁-Zₘ represent the positional embedding. Spatial Transformer encoder 324 takes the multi-resolution tokens (0, 1, . . . , M) to produce a representation per frame group 308 (e.g., representation 1, 2, . . . , T) at its time step. While there is one spatial Transformer encoder 324, two are illustrated in the figure because each frame group will go through the spatial Transformer encoder separately separately. The temporal Transformer encoder 326 then aggregates across time steps. To predict a video quality score, the model prepends a “classification token” (ZCLS and HCLS) to the sequence to represent the whole sequence input and to use its output as the final representation. The output of the temporal Transformer encoder 326 may be fed to a multi-layer perceptron (MLP) 328 (which may be a single fully connected layer), which can issue predicted video quality score 330. The video quality score may be a mean opinion score when training on a data set. These features are discussed in further detail below.

### Multi-Resolution Video Representation

UGC videos are produced from highly diverse conditions and therefore may contain complex distortions and diverse resolutions. In order to capture both global and local quality information, the input video is transformed into groups of multi-resolution frames. Multiple neighboring input frames are grouped together and rescaled into a pyramid of low-resolution and high-resolution frames (e.g., 304 in FIG. 3A). Patches are then sampled from low-resolution and high-resolution frames (e.g., 306 in FIG. 3A), allowing the Transformer to aggregate information across multiple scales and spatial locations.

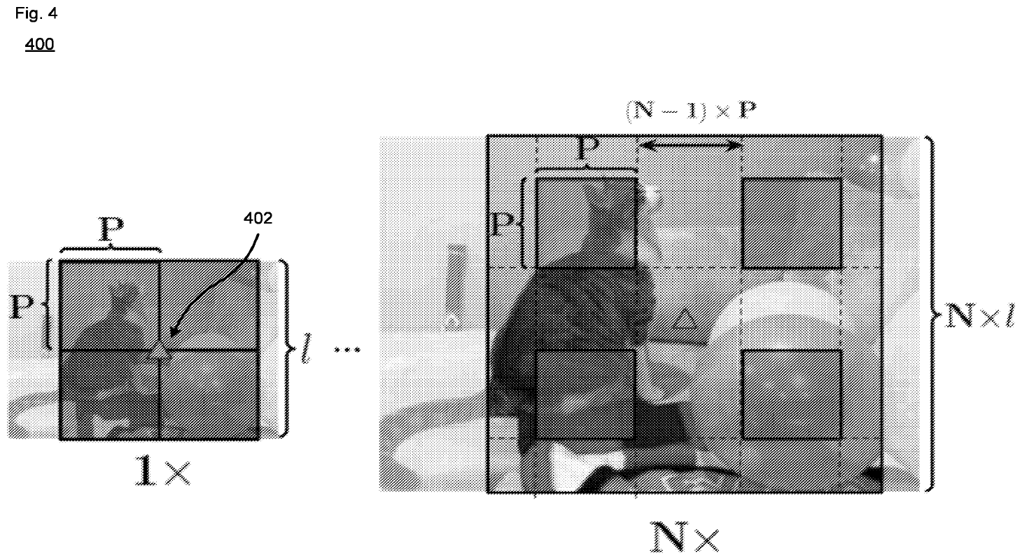

To obtain the multi-resolution video representation, the system first divides the input frames by a group of N. The N frames in the group are first proportionally resized to N different resolutions preserving the same aspect ratio. The i-th frame is resized to shorter-side length i×l accordingly, where l is the smallest length. This results in a pyramid of rescaled frames with shorter-side length as 1×l; 2×l, . . . . N×l as shown in view 400 of FIG. 4.

Intuitively, the lower-resolution frames in the multiresolution pyramid provide global views of the video composition, and the higher-resolution ones contain local details. These views are complementary to each other. Low-resolution frames can be processed efficiently while processing the high-resolution frames in its entirety can be computationally expensive. Therefore, the system relies on low-resolution frames for a global view, and performs patch sampling on high-resolution frames to provide the local details. Moreover, the Transformer should be provided with spatially aligned global and local views to allow it to better aggregate multi-scale information across locations. To achieve this, spatially aligned grid of patches may be sampled from the grouped multi-resolution frames.

FIG. 4 demonstrates the patch sampling mechanism from the frame group. The patch grid centers are aligned for each frame, as shown by the red triangle 402. During training of the model, the center can be chosen randomly along the middle line for the longer-length side. For inference, the model can use the center of the video frames. From the first frame, the system may continuously (or uniformly) sample the grid patches to capture the complete global view. For the following frames, the system may sample linearly spaced-out patches to provide local details. The patch size P is the same for all the frames. For the i-th frame, the distance between patches is set to (i−1)×P. Since the patch distance scales linearly with the rescaling length, the centers of the patches are aligned at the same location for each proportionally resized frame.

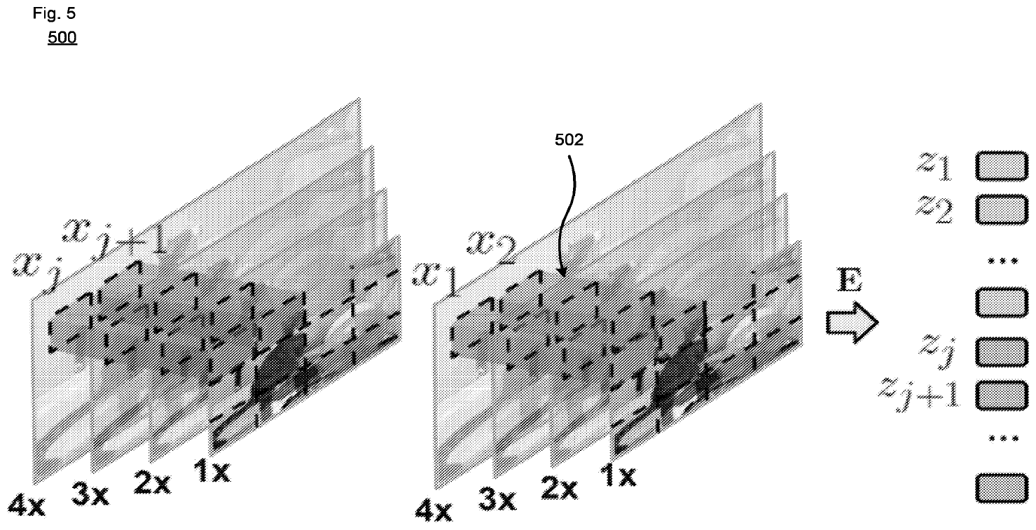

As a result, a “tube” of multi-resolution patches is formed, which is shown in the multi-resolution video frames embedding view 500 of FIG. 5 as 502. Since this tube of patches has the same center in the frames, the patches at the same location in the grid provide a gradual “zoom-in” view, capturing both the global view and local details at the same location. The system extracts multi-resolution patches and linearly projects the spatially aligned “tubes” of patches to 1D tokens.

In particular, the system linearly projects each tube of multi-resolution patch xᵢ to a 1D token zᵢ∈ [symbol] ^{d} using learned matrix E. Here, d is the dimension of the Transformer input tokens. This can be implemented using a 3D convolution with kernel size N×P×P. Each embedded token contains multi-resolution patches at the same location, allowing the model to utilize both global and local spatial quality information. Moreover, the multi-scale patches also fuse local spatial-temporal information together during tokenization. Therefore, it provides a comprehensive representation for the input video.

### Factorized Spatial Temporal Transformer

As shown in FIG. 3B, after extracting the multi-resolution frame embedding, the system applies a factorization of spatial and temporal Transformer encoders 324 and 326 in series to efficiently encode the space-time quality information. Firstly, the spatial Transformer encoder 324 takes the tokens from each frame group to produce a latent representation per frame group. It serves as the representation at this time step. Secondly, the temporal Transformer encoder 326 models temporal interaction by aggregating the information across time steps.

The spatial Transformer encoder 324 aggregates the multiresolution patches extracted from the entire frame group to a representation hₖ∈ [symbol] ^{d} at its time step. k=1, . . . T is the temporal index for the frame group. T is the number of frame groups. As mentioned above, for multi-resolution patches xᵢ from each frame group, it is projected to a sequence of multi-resolution tokens as zᵢ∈ [symbol] ^{d}, i=1, . . . , M using learnable matrix E. M is the total number of patches. The system may prepend an extra learnable “classification token” z_{cis}∈ [symbol] ^{d} and use its representation at the final encoder layer as the final spatial representation for the frame group. A learnable spatial positional embedding p∈ [symbol] ^{M×d} may be added element-wisely to the input tokens zᵢ to encode spatial positional information. The tokens are then passed through a Transformer encoder with L layers. Each layer q consists of multi-head self-attention (MSA), layer normalization (LN), and MLP blocks. The spatial Transformer encoder can therefore be formulated as:

$${z}_{0} = [ {z}_{cls} , {E}_{x 1} {E}_{x 2} , … , {E}_{xM} ] + p \qquad ( 1 )$$

$${z}_{q}^{′} = MSA ( LN ( {z}_{q - 1} ) ) + {z}_{q - 1} , q = 1 … L \qquad ( 2 )$$

$${z}_{q} = MLP ( LN ( {z}_{q}^{′} ) ) + {z}_{q}^{′} , q = 1 … L \qquad ( 3 )$$

$${h}_{k} = LN ( {z}_{L}^{0} ) \qquad ( 4 )$$

The temporal Transformer encoder models the interactions between tokens from different time steps. After getting the frame group level representations hₖ, i=1, . . . , Tat each temporal index, the system prepends a h_{cis} ∈ [symbol] ^{d} token. A separate learnable temporal positional embedding ∈ [symbol] ^{T×d} is also added. The output tokens are then fed to the temporal Transformer encoder 326. The output representation at the h_{cis} token is used as the final representation for the whole video.

To predict the final quality score 320, MLP layer 328 is added on top of the final representation output from the h_{cis} token position from the temporal encoder 326. The output of the MLP layer 328 can be regressed to the video mean opinion score (MOS) label associated with each video in VQA datasets. In one scenario, the model is trained end-to-end with L₂ loss.

Initialization from Pretrained Models

Available video quality datasets may be several magnitudes smaller than large-scale image classification datasets, such as ILSVRC-2012 ImageNet and ImageNet-21k. Given this, training Transformer models from scratch using VQA datasets can be extremely challenging and impractical. Therefore, according to one aspect the Transformer backbone may be initialized from pretrained image models.

Unlike 3D video input, image Transformer models only need 2D projection for the input data. To initialize the 3D convolutional filter E from 2D filters E_{image} in pretrained image models, a “central frame initialization strategy” cam be adopted. In short, E is initialized with zeros along all temporal positions, except at the center └N/2┘. The initialization of E from pretrained image model can therefore be formulated as:

$$E = [ 0 , … , {E}_{image} , … , 0 ] \qquad ( 5 )$$

### Example Implementation and Test Results

As shown in the test results below, experiments were run on four UGC VQA datasets, including LSVQ, LSVQ-1080p, KoNVID-1k, and LIVE-VQC. LSVQ (excluding LSVQ-1080p) included 38,811 UGC videos and 116,433 space-time localized video patches. The original and patch videos were all annotated with MOS scores in [0.0, 100.0], and it contained videos of diverse resolutions. The LSVQ-1080p set contained 3,573 videos with 1080p resolution or higher. Since in one scenario the model does not make a distinction between original videos and video patches, all the 28.1k videos and 84.3k video patches from the LSVQ training split were used to train the model. The model was evaluated on full-size videos from the testing splits of LSVQ and LSVQ-1080p. KoNVID-1k contained 1,200 videos with MOS scores in [0.0, 5.0] and 960p fixed resolution. LIVE-VQC contained 585 videos with MOS scores in [0.0, 100.0] and video resolution from 240p to 1080p. KoNVID-1k and LIVE-VQC were used for evaluating the generalization ability of the model without fine-tuning. Since no training was involved in that testing, the entire dataset was used for evaluation.

For testing, the number of multi-resolution frames in each group was set to N=4. The shorter-side length l was set to 224 for the first (smallest) frame in the frame group. Correspondingly, the following three frames were rescaled with shorter-side (pixel) length 448, 672, and 896. Patch size P=16 was used when generating the multi-resolution frame patches. For each frame, a 14_14 grid of patches was sampled. Unless otherwise specified herein, the input to the network was a video clip of 128 frames uniformly sampled from the video.

The hidden dimension for Transformer input tokens for testing was set to d=768. For the spatial Transformer encoder (e.g., 324 in FIG. 3B), the ViT-Base model was used (12 Transformer layers with 12 heads and 3072 MLP size), and it was initialized from the checkpoint trained on ImageNet-21K. For the temporal Transformer encoder (e.g., 326 in FIG. 3B), 8 Transformer layers were used with 12 heads, and 3072 MLP size. The final model included around 144M parameters and 577 GFLOPS.

The models were trained with the synchronous SGD momentum optimizer, a cosine decay learning rate schedule from 0.3 and a batch size of 256 for 10 epochs in total. All the models were trained for testing on tensor processing unit, version 3 (TPUv3) hardware. Spearman rank ordered correlation (SRCC) and Pearson linear correlation (PLCC) were reported as performance metrics.

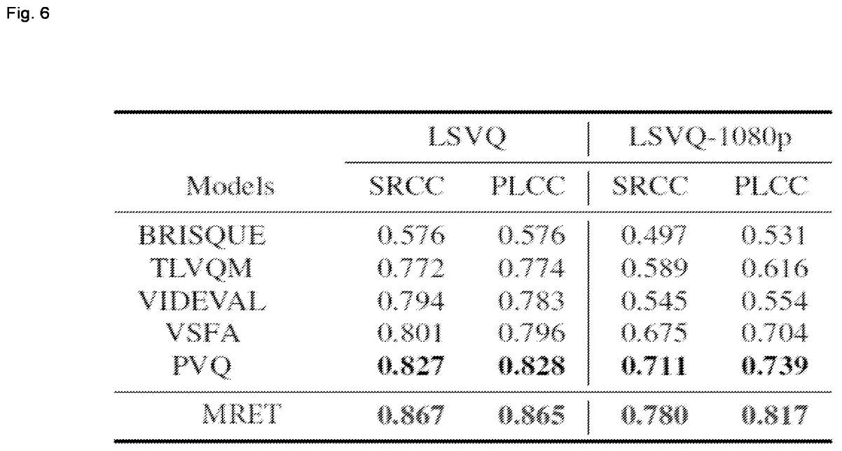

Table 1 in FIG. 6 shows the results on full-size LSVQ and LSVQ-1080p datasets. The bolded numbers represent the best results. As shown in the bolded bottom row, MRET outperformed most other methods by large margins on both datasets. Notably, on the higher resolution test dataset LSVQ-1080p, the MRET model was able to outperform the strongest baseline by 7.8% for PLCC (from 0.739 to 0.817). This shows that for high-resolution videos, the MRET multi-resolution Transformer is able to better aggregate local and global quality information for a more accurate video quality prediction.

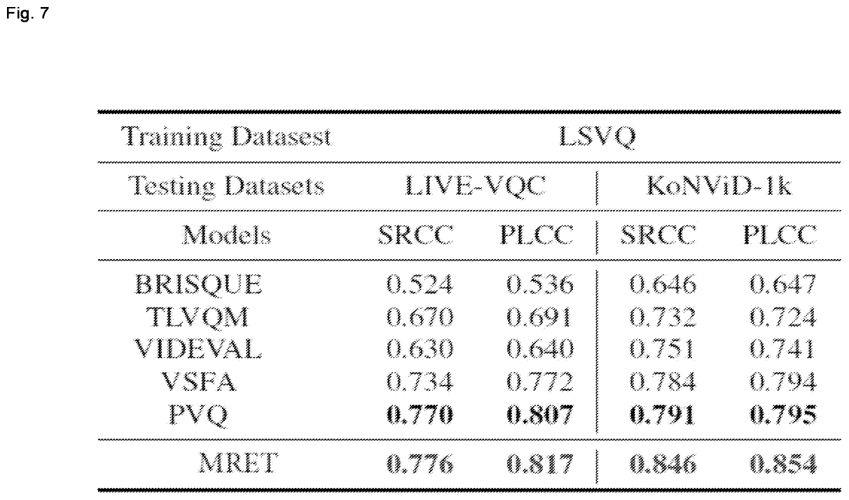

To verify the generalization capability of the MRET model, a cross-dataset evaluation was conducted in which the model was trained using LSVQ training set and separately evaluated on LIVE-VQC and KoNVID-1k without fine-tuning. As shown in Table 2 of FIG. 7, MRET is able to generalize very well to both datasets. Specifically, the model surpassed the strongest baseline by 1.0% and 5.9% in PLCC on LIVE-VQC and KoNVID-1k datasets respectively, demonstrating strong generalization capability. With the multi-resolution input design, MRET can learn to capture information for UGC videos under different conditions.

### Ablation Studies

To understand how MRET aggregates spatial-temporal information to predict the final video quality, one can visualize the attention weights on spatial and temporal tokens using Attention Rollout, as explained by Abnar and Zuidema in “Quantifying attention flow in transformers”, 2020, the disclosure of which is incorporated by reference herein. In short, the attention weights of the Transformer are averaged across all heads and then the weight matrices of all layers are recursively multiplied.

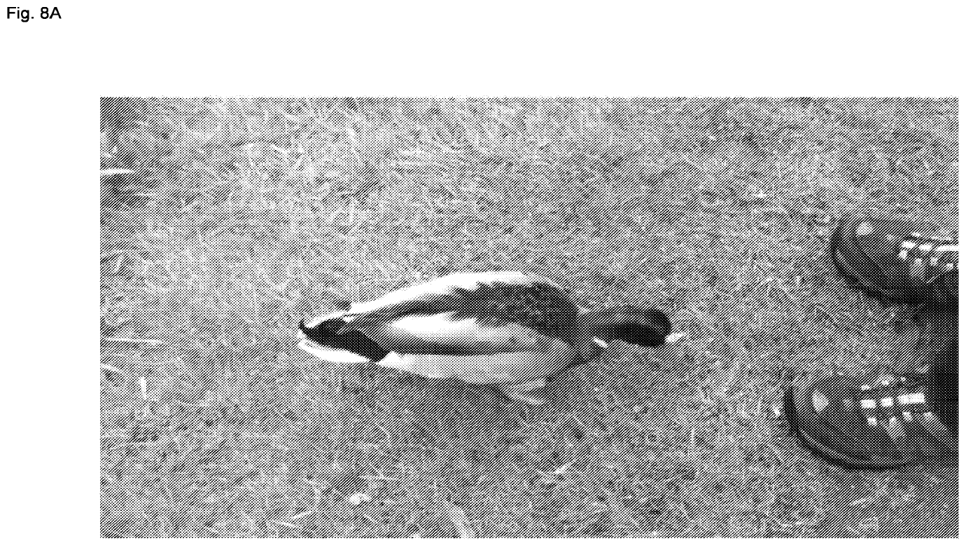

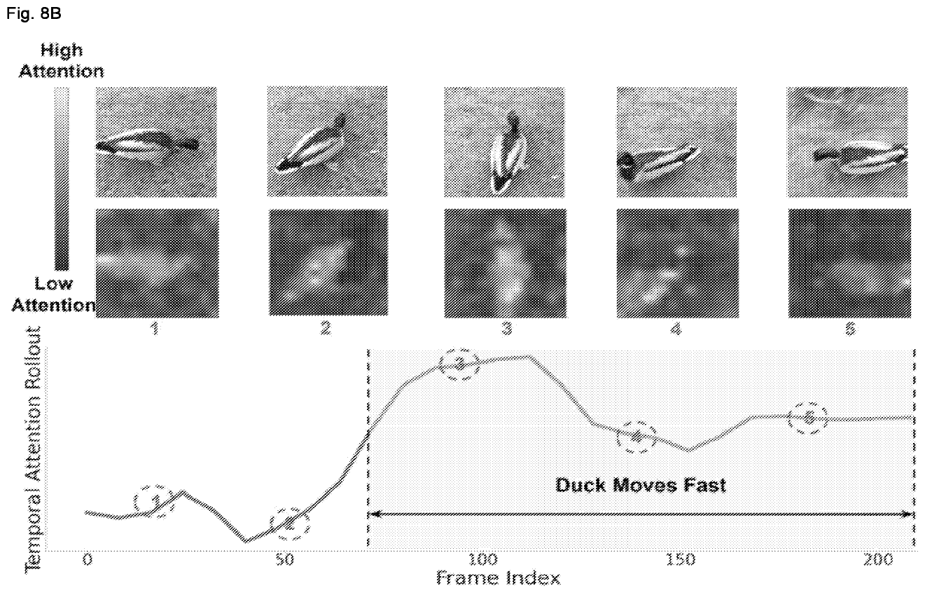

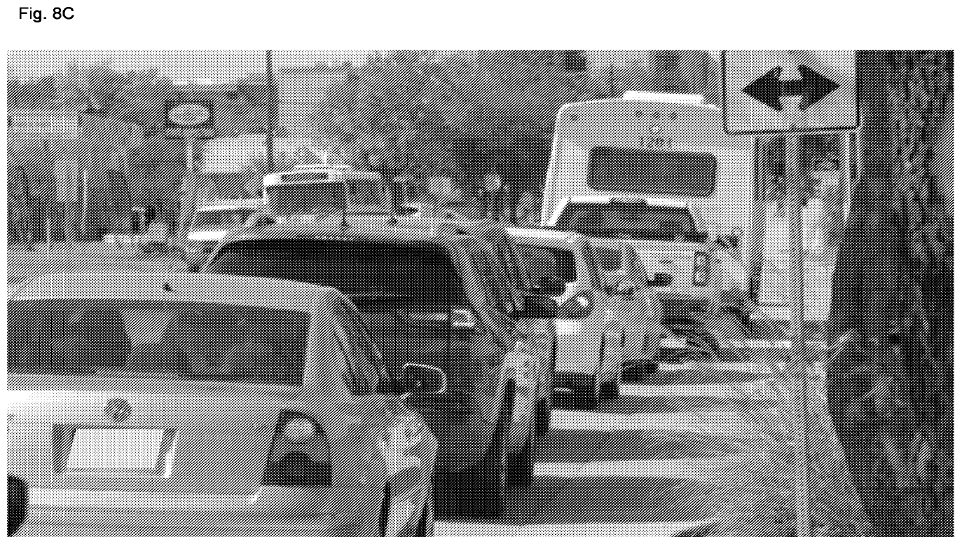

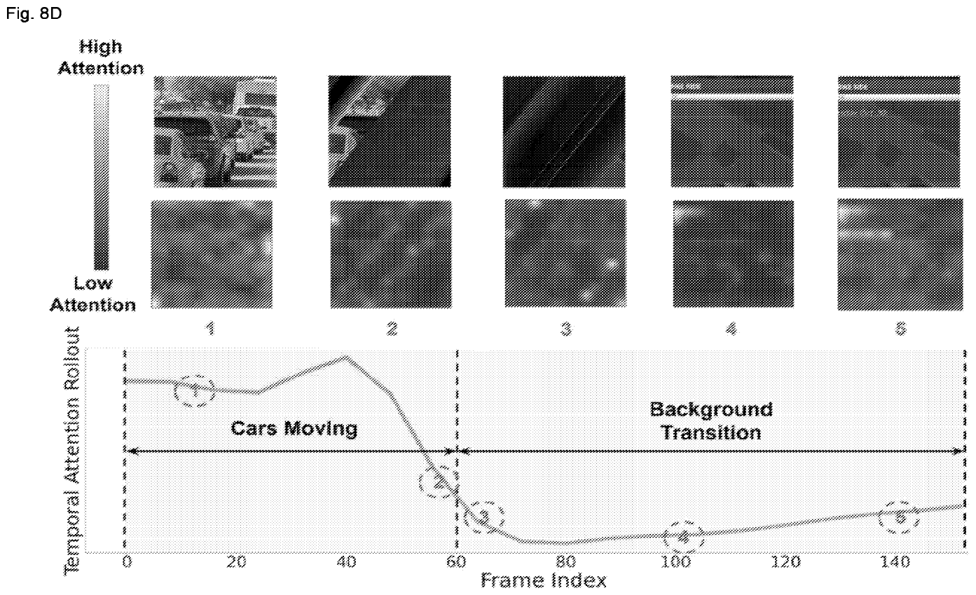

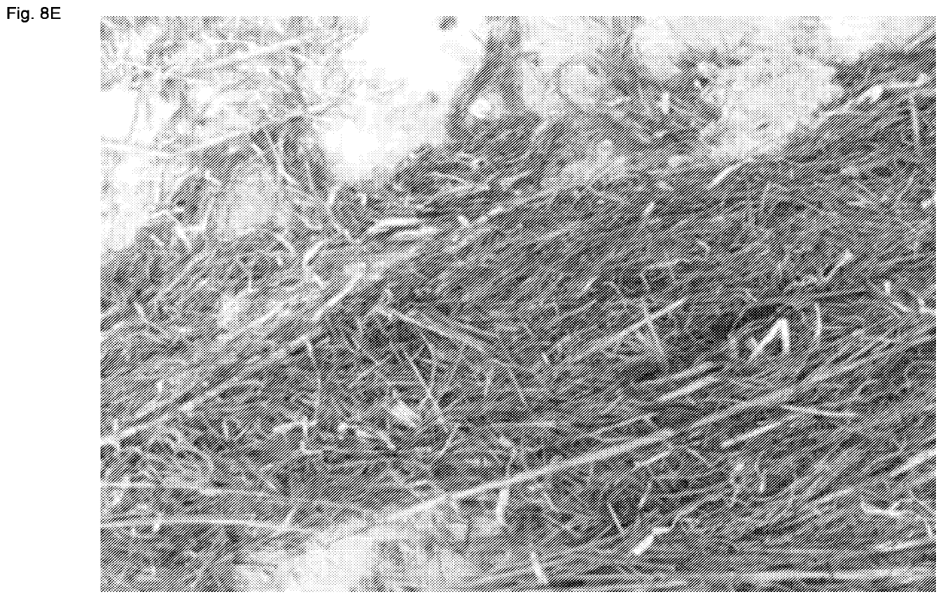

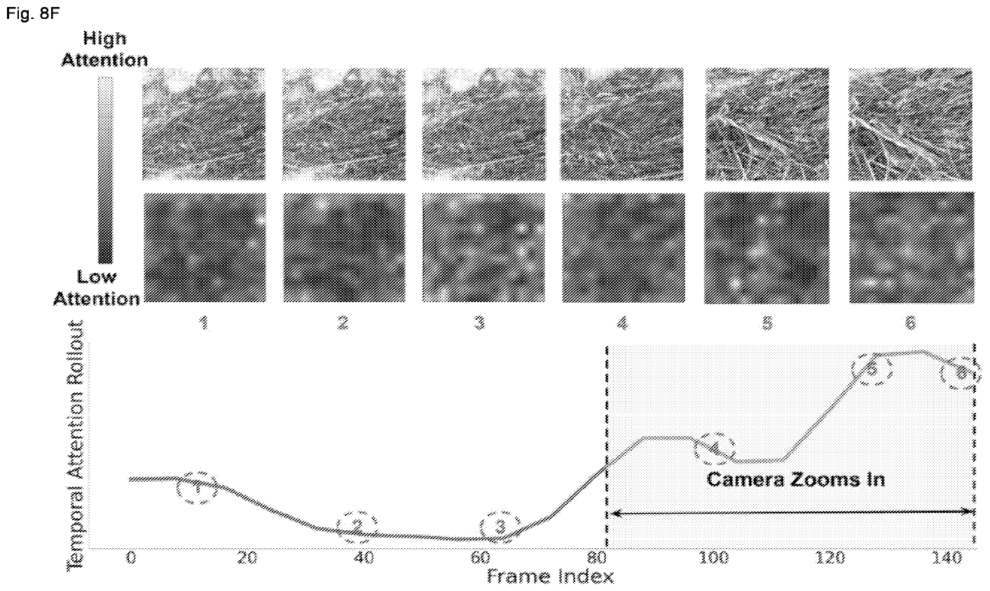

FIGS. 8A-F visualize temporal attention for each input time step and spatial attention for selected frames of three different samples. In particular, visualization of spatial and temporal attention from output tokens to the input. The heat-maps in the upper parts of FIGS. 8B, 8D and 8F show the spatial attention. The charts in the lower parts of those figures show the temporal attention. Higher attention values correspond to the more important video segments and spatial regions for prediction. The model is focusing on spatially and temporally more meaningful content when predicting the final score.

As shown by temporal attention for the duck video in FIGS. 8A-B, the model is paying more attention to the second section when the duck is moving rapidly across the grass. The spatial attention also shows that the model is focusing on the main subject, i.e., duck in this case. For the traffic video of FIGS. 8C-D, cars are moving in the first section of the video, which catches the attention of the model. The later background transition part has monotonic color tone and is relatively bland and the model is “ignoring” this less meaningful part. The video in FIGS. 8E-F starts to zoom in half way and the model is paying increasing attention to the later frames as the center object (a small crab) becomes bigger and there is more motion. These examples verify that MRET is able to capture spatial-temporal quality information and utilize it to predict the video quality.

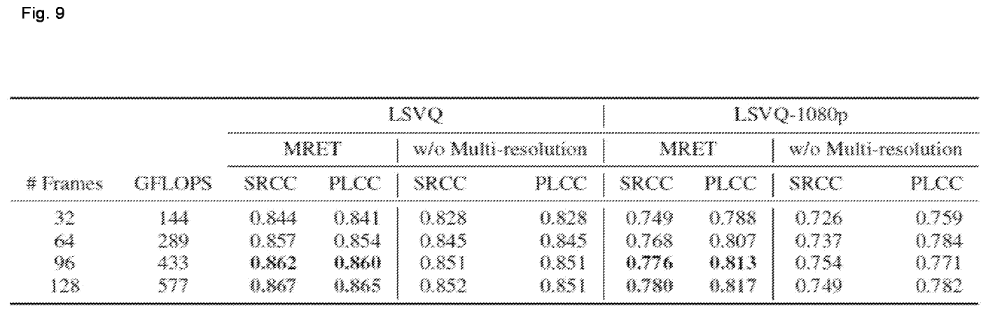

To verify the effectiveness of the multi-resolution input representation, ablations were run by not using the multi-resolution input. The comparison result is shown in Table 3 of FIG. 9 as “MRET” and “w/o Multi-resolution” for with and without the multi-resolution frames respectively. These results are for multi-resolution input on LSVQ and LSVQ-1080p datasets. MRET uses multi-resolution input while “w/o Multi-resolution” uses fixed-resolution frames. Both models grouped the frames by N=4 when encoding video frames into tokens. The bolded numbers represent the best results on the same dataset.

In this test, For MRET the frames were resized to [224, 448, 672, 896] for shorter-side lengths. For the method “w/o Multiresolution”, all the frames in the frame group were resized to the same shorter-side length, which is 224. The GFLOPS are the same for both models because the patch size and number of patches are the same. As shown in the table, the multi-resolution frame input brings 1-2% boost in SRCC on LSVQ and 2-3% boost in SRCC on LSVQ-1080p. The gain is larger on LSVQ-1080p because the dataset contains more high-resolution videos, and therefore more quality information is lost when resized statically to a small resolution.

Armed with the multi-resolution input representation, MRET is able to utilize both global information from lower-resolution frames and detailed information from higher-resolution frames. The results demonstrate that the proposed multi-resolution representation is indeed effective for capturing the complex multi-scale quality information that can be lost when using statically resized frames. Table 3 also shows that both models' performance improves with the increase of number of input frames since more temporal information is preserved.

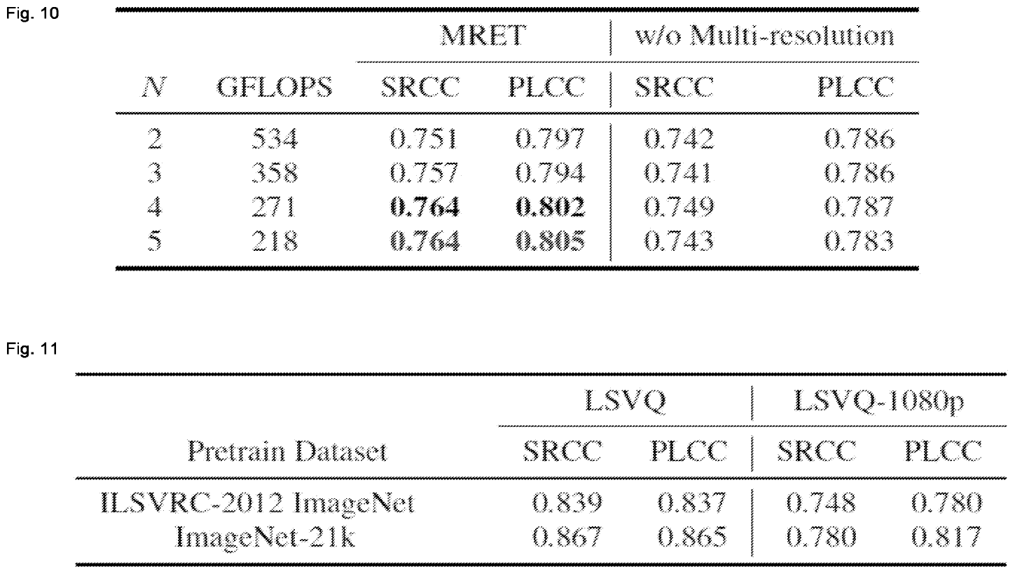

In Table 4 of FIG. 10, ablations were run on the number of grouped frames N when building the multi-resolution video representation. The experiment was run with 60 frames instead of 128 since smaller N increases the number of input tokens for the temporal encoder and introduces high computation and memory cost. For MRET, multi-resolution input was used for the grouped frames and for “w/o Multi-resolution”, all the frames were resized to the same 224 shorter-side length. For all N, using multi-resolution input is shown to be better than a fixed resolution.

This further verifies the validity of the multiresolution input structure of the MRET arrangement. For multi-resolution input, the performance improved when increasing N from 2 to 5, but the gain became smaller as N grew larger. There is also a trade-off between getting higher resolution views and the loss of spatial and temporal information with the increase of N, since the area ratio of sampled patches becomes smaller as resolution increases. Overall, it was found for N=4 to be a good balance between performance and complexity.

Compared to CNNs, Transformers impose less restrictive inductive biases, which broadens their representation ability. However, since the basic Transformer architecture lacks the inductive biases of the 2D image structure, it generally needs large datasets for pretraining to learn the inductive priors. In Table 5 of FIG. 11, experiments were run by initializing the spatial Transformer encoder in the MRET model from checkpoints pretrained using different image classification datasets. As shown in the table, pretraining the spatial Transformer backbone on large-scale datasets is indeed beneficial.

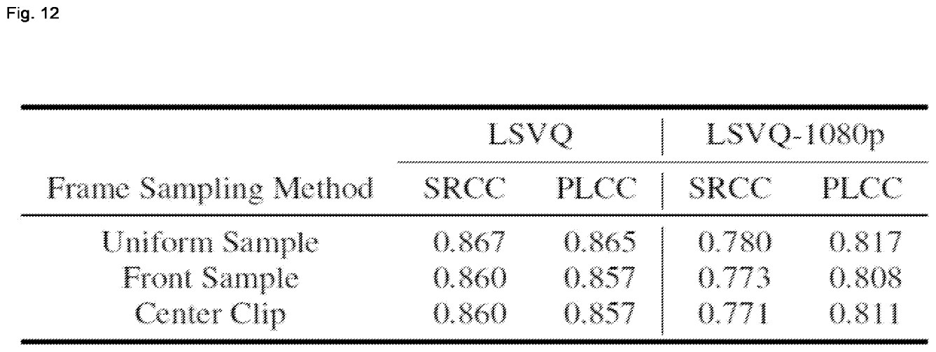

Table 6 of FIG. 12 illustrates results for ablations run on the frame sampling strategy. For the default “Uniform Sample”, 128 frames were sampled uniformly throughout the video. For the “Front Sample” method, the first 128 frames were samples, and for “Center Clip” the center clip of 128 frames was taken from the video. On LSVQ and LSVQ-1080p dataset, uniformly sampling the frames is the best, which is understood to be because there is temporal redundancy between continuous frames and uniformly sampling the frames, which allows the model to see more diverse video clips. Since most of the videos in the tested VQA dataset were relatively short, uniformly sampling the frames was good enough to provide a comprehensive view. Other frame sampling strategies may be more effective when videos are longer. In addition or alternatively, one can also resort to an ensemble score from different video clips in such scenarios.

### Example Computing Architecture

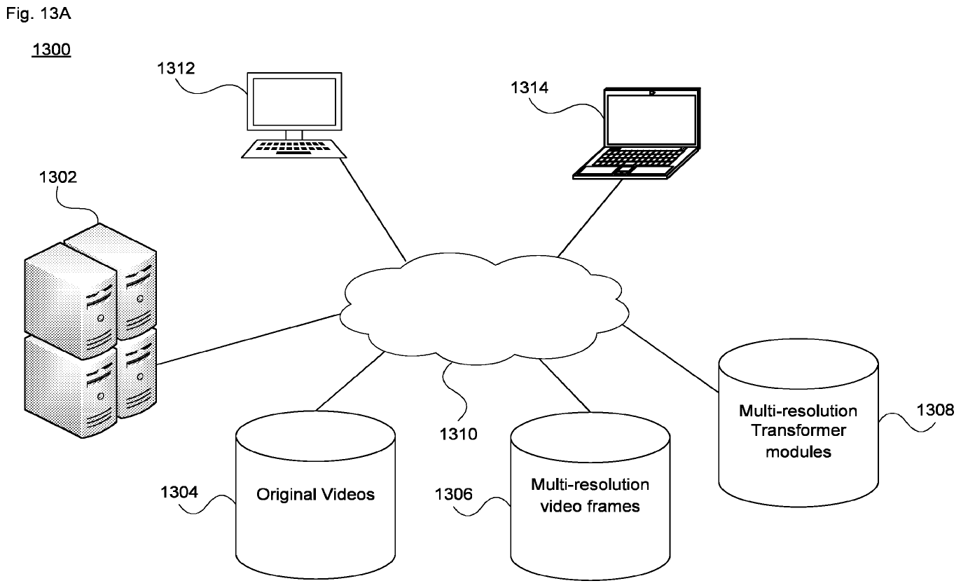

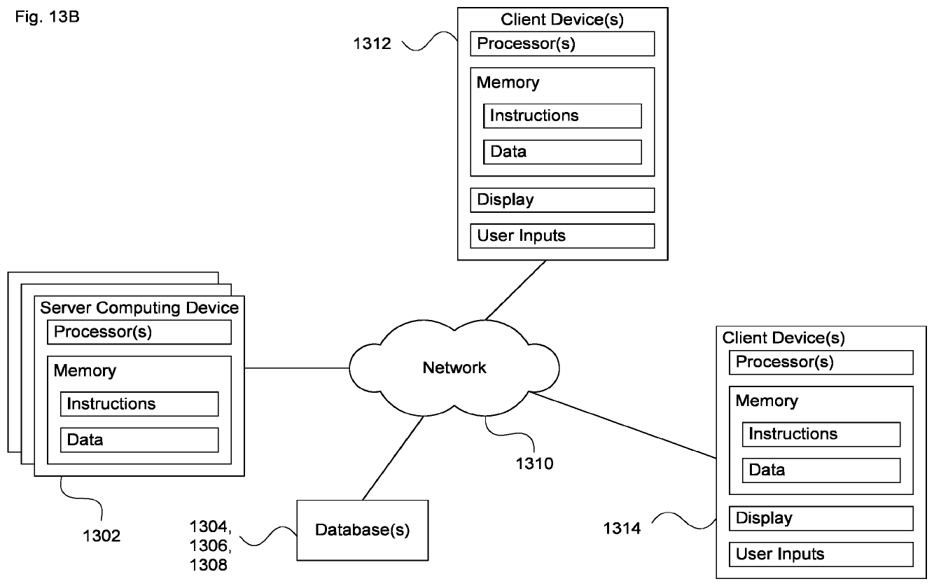

The models may be trained on one or more tensor processing units (TPUs), CPUs or other computing architectures in order to implement a multi-resolution Transformer for video imagery in accordance with the features disclosed herein. One example computing architecture is shown in FIGS. 13A and 13B. In particular, FIGS. 13A and 13B are pictorial and functional diagrams, respectively, of an example system 1300 that includes a plurality of computing devices and databases connected via a network. For instance, computing device(s) 1302 may be a cloud-based server system. Databases 1304, 1306 and 1308 may store, e.g., the original videos, multi-resolution video frames and/or multi-resolution Transformer modules (such as the multi-resolution embedding module, spatial transformer encoder and temporal transformer encoder, etc.), respectively. The server system may access the databases via network 1310. Client devices may include one or more of a desktop computer 1312 and a laptop or tablet PC 1314, for instance to provide the original videos and/or to view the output visualizations (e.g., video quality assessment(s) or use of the assessment or other information in a video service, app or other program).

As shown in FIG. 13B, each of the computing devices 1302 and 1312-1314 may include one or more processors, memory, data and instructions. The memory stores information accessible by the one or more processors, including instructions and data (e.g., models) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphical processing units (GPUs), etc. Alternatively, each processor may be a dedicated device such as an ASIC or other hardware-based processor. Although FIG. 13B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1302. Accordingly, references to a processor or computing device will be understood to include references to a collection of processors or computing devices or memories that may or may not operate in parallel.

The input data, such as one or more videos or sets of videos, may be operated on by a multi-resolution Transformer module to generate one or more multi-resolution video frame representations, video quality assessment data, etc. The client devices may utilize such information in various apps or other programs to perform video quality assessment or other metric analysis, video recommendations, video classification, video search, etc. This could include assigning quality scores to different videos based upon the results of MRET processing, for instance to contrast videos that have a high level of artifacts from other videos with a lower level of artifacts. Therefore, quality scores can be used to rank videos and prioritize good videos in serving, such as for a video streaming service. Video processing or editing operations may be selected that lead to a better quality score.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 1312-1314) may communicate with a back-end computing system (e.g., server 1302) via one or more networks, such as network 1310. The network 910, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 1302 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 1302 may include one or more server computing devices that are capable of communicating with any of the computing devices 1312-1314 via the network 1310.

Video quality assessment information or other data derived from the multi-resolution Transformer module(s), the module(s) itself, multi-resolution video frames or other representations, or the like may be shared by the server with one or more of the client computing devices. Alternatively or additionally, the client device(s) may maintain their own databases, MRET modules, etc.

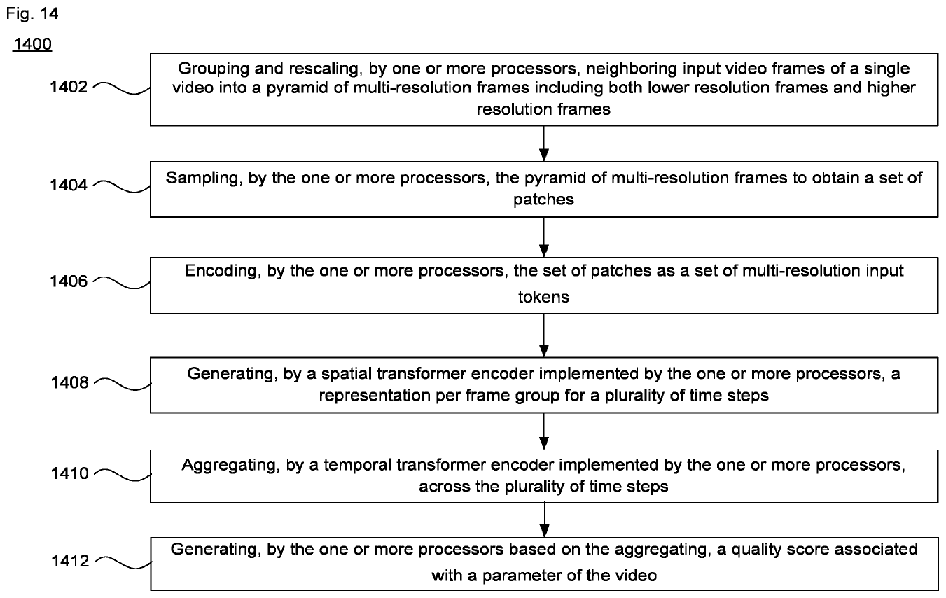

FIG. 14 illustrates a method for processing videos in accordance with aspects of the technology. At block 1402, the method includes grouping and rescaling, by one or more processors, neighboring input video frames of a single video into a pyramid of multi-resolution frames including both lower resolution frames and higher resolution frames. At block 1404, the method includes sampling, by the one or more processors, the pyramid of multi-resolution frames to obtain a set of patches. At block 1406, the method includes encoding, by the one or more processors, the set of patches as a set of multi-resolution input tokens. At block 1408, the method includes generating, by a spatial transformer encoder implemented by the one or more processors, a representation per frame group for a plurality of time steps. At block 1410, the method includes aggregating, by a temporal transformer encoder implemented by the one or more processors, across the plurality of time steps. And at block 1412, the method includes generating, by the one or more processors based on the aggregating, a quality score associated with a parameter of the video.

As explained above, a multi-resolution Transformer (MRET) is provided for video quality assessment and other video-related applications and services. The MRET integrates multi-resolution views to capture both global and local quality information. By transforming the input frames to a multi-resolution representation with both low and high resolution frames, the model is able to capture video quality information at different granularities. A multi-resolution patch sampling mechanism is provided to effectively handle the variety of resolutions in the multi-resolution input sequence. A factorization of spatial and temporal Transformers is employed to efficiently model spatial and temporal information and capture complex space-time distortions in UGC videos. Experiments on several large-scale UGC VQA datasets have shown that MRET can achieve state-of-the-art performance and has strong generalization capability, demonstrating the effectiveness of the proposed method. While MRET is particularly beneficial for VQA-related applications, it can be applied to other scenarios such as where the task labels are affected by both video global composition and local details. Finally, the Transformer-based architecture can be modified to handle larger numbers of input tokens.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method for processing videos, the method comprising:
grouping and rescaling, by one or more processors, neighboring input video frames of a single video into a pyramid of multi-resolution frames including both lower resolution frames and higher resolution frames;
sampling, by the one or more processors, the pyramid of multi-resolution frames to obtain a set of patches;
encoding, by the one or more processors, the set of patches as a set of multi-resolution input tokens;
generating, by a spatial transformer encoder implemented by the one or more processors, a representation per frame group for a plurality of time steps;
aggregating, by a temporal transformer encoder implemented by the one or more processors, across the plurality of time steps; and
generating, by the one or more processors based on the aggregating, a quality score associated with a parameter of the video.

2. The method of claim 1, further comprising prepending a set of classification tokens to the set of multi-resolution input tokens.

3. The method of claim 1, wherein generating the quality score includes applying aggregated output from the temporal transformer encoder to a multi-layer perceptron model.

4. The method of claim 1, wherein the quality score is a mean opinion score.

5. The method of claim 1, wherein the encoding includes capturing both global video composition from the lower resolution frame and local details from the higher resolution frames.

6. The method of claim 1, wherein the grouping and rescaling includes:
dividing the neighboring input video frames by a group of N; and
proportionally resizing the group of N to N different resolutions preserving a same aspect ratio; wherein an i-th frame is resized to shorter-side length i×l, where l is a smallest length.

7. The method of claim 1, wherein:
sampling the pyramid of multi-resolution frames to obtain a set of patches includes aligning patch grid centers for each frame;
during model training, randomly choosing a center for each frame along a middle line for a longer-length side; and
for inference, using the center of the video frames.

8. The method of claim 1, wherein sampling the pyramid of multi-resolution frames to obtain a set of patches includes:
from a first one of the neighboring input video frames, uniformly sampling grid patches to capture a complete global view; and
for following ones of the neighboring input video frames, linearly sampling spaced-out patches to provide local details.

9. The method of claim 1, wherein a patch size P is the same for all of the multi-resolution frames in the pyramid.

10. The method of claim 9, wherein, for the i-th frame in the pyramid, the distance between patches is set to (i−1)×P.

11. The method of claim 1, wherein sampling the pyramid of multi-resolution frames to obtain a set of patches includes forming a tube of multi-resolution patches, the tube having the same center in through the pyramid of multi-resolution frames.

12. A video processing system, comprising:
memory configured to store imagery; and
one or more processors operatively coupled to the memory, the one or more processors being configured to:
group and rescale neighboring input video frames of a single video into a pyramid of multi-resolution frames including both lower resolution frames and higher resolution frames;
sample the pyramid of multi-resolution frames to obtain a set of patches;
encode the set of patches as a set of multi-resolution input tokens;
generate, by a spatial transformer encoder implemented by the one or more processors, a representation per frame group for a plurality of time steps;
aggregate, by a temporal transformer encoder implemented by the one or more processors, across the plurality of time steps; and
generate, based on the aggregating, a quality score associated with a parameter of the video.

13. The video processing system of claim 12, wherein the one or more processors are further configured to prepend a set of classification tokens to the set of multi-resolution input tokens.

14. The video processing system of claim 12, wherein generation of the quality score includes applying aggregated output from the temporal transformer encoder to a multi-layer perceptron model.

15. The video processing system of claim 12, wherein encoding the set of patches includes capturing both global video composition from the lower resolution frame and local details from the higher resolution frames.

16. The video processing system of claim 12, wherein grouping and rescaling neighboring input video frames includes:
division of the neighboring input video frames by a group of N; and
proportionally resizing the group of N to N different resolutions preserving a same aspect ratio; wherein an i-th frame is resized to shorter-side length i×l, where l is a smallest length.

17. The video processing system of claim 12, wherein:
the one or more processors are configured to sample the pyramid of multi-resolution frames to obtain a set of patches by alignment of patch grid centers for each frame;
during model training, the one or more processors are configured to randomly choose a center for each frame along a middle line for a longer-length side; and
for inference, the one or more processors are configured to use the center of the video frames.

18. The video processing system of claim 12, wherein the one or more processors are configured to sample the pyramid of multi-resolution frames to obtain a set of patches as follows:
from a first one of the neighboring input video frames, uniformly sample grid patches to capture a complete global view; and
for following ones of the neighboring input video frames, linearly sample spaced-out patches to provide local details.

19. The video processing system of claim 12, wherein the one or more processors are configured to sample the pyramid of multi-resolution frames to obtain a set of patches by formation of a tube of multi-resolution patches, the tube having the same center in through the pyramid of multi-resolution frames.

20. The video processing system of claim 12, wherein a patch size P is the same for all of the multi-resolution frames in the pyramid.

21. The video processing system of claim 12, wherein the one or more processors are further configured to assign quality scores to different videos in order to prioritize the different videos for serving.
